(19) United States
(12) Patent Application Publication
(10) Pub. No.: US 2006/0047508 A1
(43) Pub. Date: Mar. 2, 2006

(54) Speech processing apparatus and method

(76) Inventor: Yasuo Okutani, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/210,933

(22) Filed: Aug. 24, 2005

(30) Foreign Application Priority Data
Aug. 27, 2004 (JP) 2004-249015

(51) Int. Cl. G10L 19/00

(52) U.S. Cl. 704/230

(57) ABSTRACT

A speech processing apparatus and method for restricting use of generated speech data for purposes other than a particular purpose. An adder adds predetermined audio data within audio-frequency band excluding predetermined frequency band, to input speech data. A band limiting filter limits the speech data to which the predetermined audio data has been added by the adder, to the predetermined frequency band. A communication device transmits the speech data which has been limited to the predetermined frequency band by the band limiting filter.

### FIELD OF THE INVENTION

The present invention relates to a speech processing apparatus and method, and in particular to a technique for restricting use of generated speech data for purposes other than a particular purpose.

### BACKGROUND OF THE INVENTION

There are proposed telephone answering apparatuses which create a voice response message by utilizing a speech synthesis technique. For example, a speech-synthesis telephone answering apparatus described in Japanese Patent Laid-Open No. 63-124653 employs a method in which a response is made by converting a response message sentence, which has been created by an editor, to speech through speech synthesis. This technique is advantageous in that a user can insert his name in the message while keeping his voice unknown to others.

Similar to speech obtained by reproducing recording, there also exists a model speaker for speech synthesis who utters speech which is to be the base of the speech synthesis. In general, manufacturers make a contract with a model speaker which clarifies the purpose of use. In the above example, the purpose is use as a response message of a telephone answering apparatus. However, it is possible to reproduce a response message of a telephone answering apparatus from a speaker for checking. Therefore, it is conceivable that the synthesized speech reproduced from a speaker is used for other purposes. Accordingly, the manufactures are required to take measures to prevent the speech from being used for other purposes. It goes without saying that similar measures must be taken for the voice response message prepared for a telephone set in advance.

As an example of other conventional techniques related to the present invention, there is a technique described in Japanese Patent Laid-Open No. 02-68773. In this document, there is disclosed an audio signal reproduction apparatus which generates noise consisting of high-frequency band components among non-audio-frequency bands and adds the noise on an analog audio signal of an audio-frequency band for the purpose of improving sound quality. In this document, however, there is no description nor suggestion at all about generating noise consisting of audio-frequency band components and adding the noise on a speech to prevent a voice response message from being used for purposes other than an intended purpose.

The speech-synthesis telephone answering apparatus in Japanese Patent Laid-Open No. 63-124653 has a lot of merits to be enjoyed by users. However, it has a problem that, though the main purpose is use as a response message of a telephone, use for purposes other than an intended purpose is easily possible because any message can be created.

### SUMMARY OF THE INVENTION

In view of the above problems in the conventional art, the present invention has an object to prevent generated speech data from being used for purposes other than a particular purpose.

In one aspect of the present invention, a speech processing apparatus having communication means, includes acquisition means for acquiring speech data, addition means for adding predetermined audio data within audio-frequency band excluding predetermined frequency band, to the speech data acquired by the acquisition means, and band limiting means for limiting the speech data to which the predetermined audio data has been added by the addition means, to the predetermined frequency band, wherein the communication means sends the speech data which has been limited to the predetermined frequency band by the band limiting means.

The above and other objects and features of the present invention will appear more fully hereinafter from a consideration of the following description taken in connection with the accompanying drawing wherein one example is illustrated by way of example.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing the hardware configuration of a speech processing apparatus in an embodiment;

FIG. 2 is a block diagram showing the functional configuration of the speech processing apparatus in the embodiment;

FIG. 3 is a flowchart showing a process of outputting a response message to a call originator by the speech processing apparatus in the embodiment; and

FIG. 4 illustrates the frequency band of a signal generated by the speech processing apparatus in the embodiment.

### DETAILED DESCRIPTION OF THE PREFERRED EMBODIMENTS

Preferred embodiment(s) of the present invention will be described in detail in accordance with the accompanying drawings. The present invention is not limited by the disclosure of the embodiments and all combinations of the features described in the embodiments are not always indispensable to solving means of the present invention.

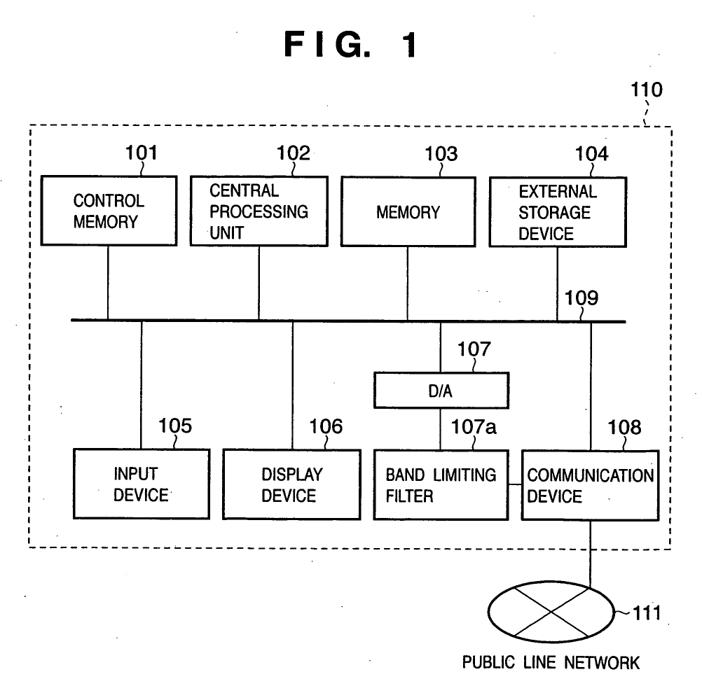

FIG. 1 is a block diagram showing the hardware configuration of a speech processing apparatus in this embodiment. In this embodiment, description will be made on a case where a so-called telephone answering function is realized by a computer using a CPU. This function can be, of course, configured by a dedicated hardware logic.

In FIG. 1, reference numeral 101 denotes a control memory (ROM) in which control programs for realizing the speech processing apparatus of this embodiment, data used by the control programs and the like are stored. Reference numeral 102 denotes a central processing unit (CPU) for controlling the apparatus, and reference numeral 103 denotes a memory (RAM) which functions as a main memory and temporarily stores various data. Reference numeral 104 denotes an external storage device such as a hard disk device and a memory card; reference numeral 105, an input device including a ten-key pad; reference numeral 106, a display device such as a liquid crystal panel; reference numeral 107, a D/A converter; reference numeral 107a, a band limiting filter; reference numeral 108, a communication device; and reference numeral 109, a bus which communicably connects each of the above devices. A telephone set 110 with a telephone answering function is configured by these devices. Reference numeral 111 denotes a public line network.

For a telephone answering apparatus, it is necessary to take measures for preventing the speech output function of the telephone answering apparatus from being used for purposes other than the purpose of outputting a response message, as described above. In this case, the response message is a message transmitted to a call originator via a telephone line (the public line network 111). Therefore, if it is output not via a telephone line,.the use can be determined to be for a purpose other than the originally intended purpose. Accordingly, in this embodiment, noise as a particular sound signal within audio-frequency bands excluding telephone-frequency bands is added on the speech signal of a response message. The “noise” stated here may be a single frequency tone or a tone including multiple frequency components only if it is within the audio-frequency bands excluding the telephone-frequency bands. When a response message with such noise added is transmitted via a telephone line, the noise is not heard. However, when a telephone line is not used (that is, when the use is considered to be for a purpose other than the originally intended purpose), the noise is heard. Thereby, use for purposes other than the originally intended purpose can be prevented.

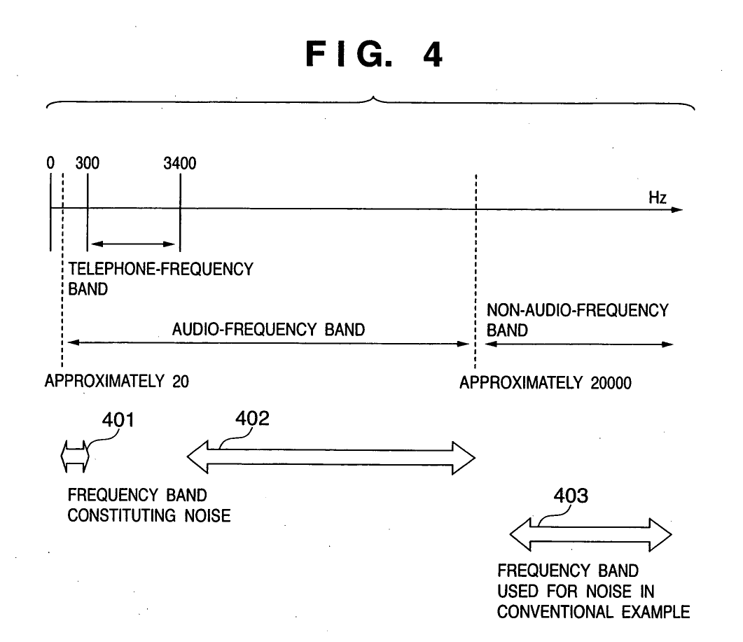

FIG. 4 shows frequency bands of speech. In general, bands audible for human beings is said to be approximately 20 Hz to 20 kHz. That is, sounds of other frequency bands are considered not to be heard. A telephone we usually utilize uses a part of the audio-frequency bands (300 Hz to 3.4 kHz). In this embodiment, for such speech that usable bands are limited, such as to the telephone-frequency bands, noise consisting of frequency components within the audio-frequency bands excluding the usable bands (bands denoted by reference numerals 401 and 402 in this figure) is generated, and the noise is added on the speech signal of a response message. The audio signal reproduction apparatus described in Japanese Patent Laid-Open No. 02-68773 is apparently different from the present invention in that it uses noise of within non-audio-frequency bands denoted by reference numeral 403.

In the configuration shown in FIG. 1, the control programs and data stored in the ROM 101 are acquired into the RAM 103 as appropriate, via the bus 109 under the control of the CPU 102, and executed by the CPU 102. Digital speech maintained by the RAM 103 is converted to analog speech via the D/A converter 107. Furthermore, it is sent out to the public line network 111 by the communication device 108 after the band is limited to the telephone-frequency bands by the band limiting filer 107a.

In this case, the bands used by the public line network 111 are the telephone-frequency bands. Therefore, the pass band of the band limiting filter is generally set between 300 Hz and 3.4 kHz. Meanwhile, the digital speech signal handled in this apparatus has an audio-frequency band, that is, a band between 300 Hz to 20 kHz.

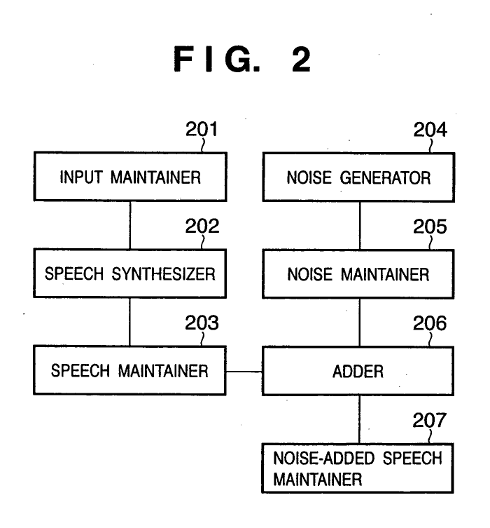

FIG. 2 is a block diagram showing the functional configuration of the speech processing apparatus in this embodiment.

In this figure, an input maintainer 201 maintains a message sentence for a speech response, which has been input by a user via the input device 105. A speech synthesizer 202 converts the message sentence maintained by the input maintainer 201 to speech by means of speech synthesis. As described above, the synthesized speech obtained here has an audio-frequency band, that is a band between 300 Hz to 20 kHz. A speech maintainer 203 maintains the speech generated by the speech synthesizer 202. A noise generator 204 generates noise consisting of frequency components within the audio-frequency bands excluding the telephone-frequency bands (for example, between 4 kHz and 20 kHz). A noise maintainer 205 maintains the noise generated by the noise generator 204. An adder 206 adds the speech maintained by the speech maintainer 203 and the noise maintained by a noise maintainer 205 to generate noise-added speech. A noise-added speech maintainer 207 maintains the noise-added speech generated by the adder 206.

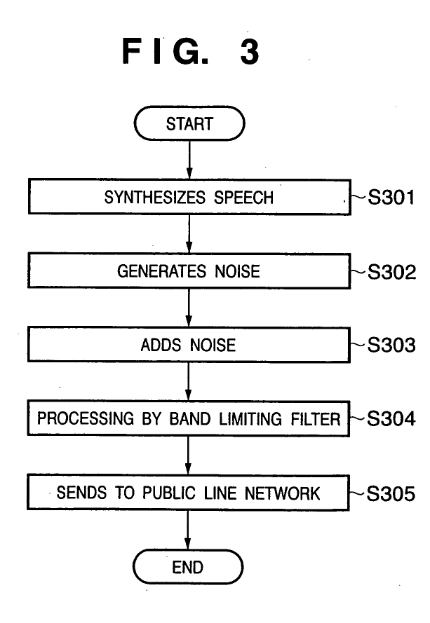

FIG. 3 is a flowchart showing a process of sending a response message to a call originator by the speech processing apparatus in this embodiment. A program corresponding to this flowchart is included in the control programs stored in the ROM 101. It is loaded to the RAM 103 and then executed by the CPU 102.

First, at step S301, the speech synthesizer 202 converts a response message sentence maintained by the input maintainer 201 to speech data. The synthesized speech data generated here has a band between 300 Hz and 20 kHz, as described above. The synthesized speech data is maintained by the speech maintainer 203.

At the next step S302, the noise generator 204 generates noise consisting of frequency components which are beyond the usable bands but within the audio-frequency bands (for example, between 4 kHz to 20 kHz). The noise is maintained by the noise maintainer 205, and the process proceeds to step S303.

At step S303, the adder 206 adds the speech maintained by the speech maintainer 203 and the noise maintained by the noise maintainer 205. The obtained noise-added speech is maintained by the noise-added speech maintainer 207, and the process proceeds to step S304.

At step S304, the noise-added speech maintained by the noise-added speech maintainer 207 is input in the D/A converter 107 and converted to an analog signal, and then, it passes through the band limiting filer 107a. Then, at step 305, the noise-added speech which has passed the band limiting filter 107a is sent by the communication device 108 to a call originator via the public line network 111, and the process ends.

All the processings performed before the conversion by the D/A converter is performed at step S304 are processings in which a digital signal is handled. This configuration is significantly different from that of the audio signal reproduction apparatus described in Japanese Patent Laid-Open No. 2-68773 which requires generation and adding of an analog noise and, therefore, cannot add noise before the D/A converter.

According to the speech output process described above, if a noise-added speech as a response message is transmitted via the public line network 111 to return the response message to a call originator, the noise component of the noise-added speech is suppressed by the band limiting filer 107a, and therefore the noise is not perceived. Meanwhile, if the noise-added speech is used not via the public line network 111, the added noise is not removed, and therefore the noise is perceived. Thus, it is possible to prevent use of a response message for purposes other than the originally intended purpose.

Though description has been made on a case where speech synthesis is employed in the embodiment described above, the present invention is not limited thereto and is applicable to the configuration in which speech recorded in advance is used. In this case, the input maintainer 201 and the speech synthesizer 202 in FIG. 2 are not required, and the configuration is such that the speech maintainer 203 maintains the speech recorded in advance. Furthermore, the step S301 in FIG. 3 is not required.

Since the embodiment described above is based on the assumption that a telephone line (the public line network 111) is used as communication means, and therefore, description has been made on a case where the telephone-frequency bands are considered to be the usable bands. However, the present invention is not limited thereto. That is, band limitation may be imposed depending on communication means used for communication with an external apparatus.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-249015 filed on Aug. 27, 2004, the entire contents of which are hereby incorporated by reference herein.

What is claimed is:

1. A speech processing apparatus having communication means, the apparatus comprising:
acquisition means for acquiring speech data;
addition means for adding predetermined audio data within audio-frequency band excluding predetermined frequency band, to the speech data acquired by said acquisition means; and
band limiting means for limiting the speech data to which the predetermined audio data has been added by said addition means, to the predetermined frequency band;
wherein said communication means sends the speech data which has been limited to the predetermined frequency band by said band limiting means.

2. The speech processing apparatus according to claim 1, wherein the predetermined frequency band is telephone-frequency band.

3. The speech processing apparatus according to claim 1, wherein said acquisition means comprises:
input means for inputting text; and
speech synthesis means for converting the input text to the speech data.

4. A speech processing method to be performed by a speech processing apparatus having communication means, the method comprising:
an acquisition step of acquiring speech data;
an addition step of adding predetermined audio data within audio-frequency band excluding a predetermined frequency band depending on the communication means, to the speech data acquired at the acquisition step;
a band limiting step of limiting the speech data to which the predetermined audio data has been added at the addition step, to the predetermined frequency band; and
a sending step of sending the speech data which has been limited to the predetermined frequency band at the band limiting step by the communication means.

5. A program to be executed by a computer having communication means, the program comprising:
a code of an acquisition step of acquiring speech data;
a code of an addition step of adding predetermined audio data within audio-frequency band excluding a predetermined frequency band depending on the communication means, to the speech data acquired at the acquisition step;
a code of a band limiting step of limiting the speech data to which the predetermined audio data has been added at the addition step, to the predetermined frequency band; and
a code of a sending step of sending the speech data which has been limited to the predetermined frequency band at the band limiting step by the communication means.

6. A telephone answering apparatus for sending speech data of a response message to a call originator, the apparatus comprising:
acquisition means for acquiring the speech data;
addition means for adding predetermined speech data within audio-frequency band excluding telephone-frequency band, to the speech data acquired by the acquisition means; and
band limiting means for limiting the speech data to which the predetermined speech data has been added by the addition means, to the telephone-frequency band; and
sending means for sending the speech data which has been limited to the telephone-frequency band by the band limiting means to the call originator.
